(19) United States
(12) Patent Application Publication
(10) Pub. No.: US 2025/0244921 A1
(43) Pub. Date: Jul. 31, 2025

(54) DEVICE MANAGEMENT SERVER, DEVICE MANAGEMENT METHOD, AND STORAGE MEDIUM

(71) Applicant: CANON KABUSHIKI KAISHA, Tokyo (JP)

(72) Inventor: NAO FUNANE, Kanagawa (JP)

(21) Appl. No.: 19/019,688

(22) Filed: Jan. 14, 2025

(30) Foreign Application Priority Data
Jan. 31, 2024 (JP) 2024-013186
Oct. 16, 2024 (JP) 2024-180626

(51) Int. Cl. G06F 3/12

(52) U.S. Cl. CPC G06F 3/1215; G06F 3/1204; G06F 3/1273

(57) ABSTRACT

A device management server which manages devices having a changeable continuous printing speed has a storage unit configured to store product information of the devices and information of consumables used in the devices in association with the devices; and a change unit configured to acquire information of consumables constituting an individual product compatible with the changed continuous printing speed from the storage unit on the basis of changed information of the continuous printing speed received from the device, to acquire information of consumables available in the individual product from the storage unit if the information of consumables associated with the device is not available in the individual product, and to perform change processing for reassociation with the device.

### BACKGROUND OF THE INVENTION

### Field of the Invention

The present invention relates to a device management server, a device management method, a storage medium, and the like.

In the related art, a continuous printing speed (PPM: page per minute) which determines a printing speed of a printer or a multifunction machine (which will be referred to as a device) is set at the time of shipment from a factory. However, if user demands are concentrated on devices having particular continuous printing speeds, it may become difficult to promptly supply desired devices.

Japanese Patent Laid-Open No. 2014-146111 proposes a method in which a license management server issues a license for changing the continuous printing speed so that settings of the continuous printing speed can be changed by performing license authentication when a device is installed at a user's site after shipment from a factory. Devices compatible with such a continuous printing speed changing function are referred to as speed license compatible devices.

In addition, generally, there are device management servers detecting errors, automatically ordering consumables, tallying up printing results, and the like for management of devices. Such device management servers are sometimes provided as cloud service systems. Devices are registered in the system such that a service provider can manage the devices.

Such device management servers may adopt a method in which devices are managed by associating master information with them. Master information is used for unitarily managing device information. Specific kinds of master information include product master information, consumables master information, and the like. Product master information defines basic information on an instrument, such as a product name, a continuous printing speed, whether it is a printer or a multifunction machine, and whether it is a color machine or a monochrome machine.

Consumables master information defines the names, colors, and capacities of consumables (toners), and with which products consumables can be used. The time-consuming work of setting the foregoing basic information for each device can be eliminated by associating the product master information with the device.

In addition, if a plurality of devices are managed, it also becomes easy to tally up a usage status, or the like for each product. In addition, it becomes easy to perform stock management, automatic ordering, and the like of consumables used in the devices by associating the consumables master information with the devices.

However, in Japanese Patent Laid-Open No. 2014-146111, the continuous printing speed of a device is changed by license authentication. When such a device having a changeable continuous printing speed is managed by a device management server, it is also necessary to change the master information to be associated before and after the license authentication.

Regarding a procedure of starting management of the device in a device management server, it is convenient to register the device in the device management server before the device is installed. Accordingly, management of the device can quickly start when the device is installed.

If the continuous printing speed has not yet been confirmed before a device is installed, a product series is associated with the device instead of a specific product as the product master information. A product series is a group of products having the same device hardware and different continuous printing speeds.

For example, it is assumed that there are a product “M1-50” with a continuous printing speed of 50 sheets per minute and a product “M1-70” of 70 sheets per minute having the same hardware. A group of these two products will be regarded as a product series such as “M1-series”.

Further, when a device is registered in a device management server, the product series such as “M1-series” is associated therewith. Moreover, consumables which will actually be used are selected from consumables available in the hardware of “M1-series” and are associated therewith. Regarding consumables, consumables which are generally available in devices differ for each unit of device hardware, namely, the product series. This depends on the device storing the consumables and the form and performance of the consumables themselves.

When a continuous printing speed is confirmed, namely, a specific product is confirmed by license authentication after a device is installed, it is time-consuming to manually update the association with the specific product on a device management server after confirmation. Particularly, if a person in charge registering a device in a device management server differs from a serviceman installing the device, a plurality of workers will be required after the device is installed.

In addition, a case in which an incorrect product series has been associated when a device is registered in a device management server and a product notified after confirmation of the continuous printing speed does not belong to the product series is conceivable. In this case, the hardware of the set product series differs from that of the actual product, and the consumables set when a device is registered may not be able to be used.

In addition, there may be cases in which consumables to be used cannot be uniquely identified, such as a case in which there are a plurality of kinds of consumables available in a product after updating. Examples of a case in which there are a plurality of kinds of available consumables include a case in which there are a standard capacity and a large capacity for toners of the same color and a case in which there are toners for new products and old products due to renewal.

### SUMMARY OF THE INVENTION

A device management server which manages devices having a changeable continuous printing speed has a storage unit configured to store product information of the devices and information of consumables used in the devices in association with the devices; and a change unit configured to acquire information of an individual product compatible with the changed continuous printing speed from the storage unit on the basis of changed information of the continuous printing speed received from the device, to acquire information of consumables available in the individual product from the storage unit if the information of consumables associated with the device is not available in the individual product, and to perform change processing for reassociation with the device.

Further features of the present invention will become apparent from the following description of embodiments with reference to the attached drawings.

### BRIEF DESCRIPTION OF THE DRAWINGS

FIG. 1 is a view showing an example of a constitution of a device management system 100 according to an embodiment of the present invention.

FIG. 2A is a view showing an example of a constitution of hardware of an information processing device 200 functioning as a device management server 101, and FIG. 2B is a view showing an example of a constitution of hardware of a device 102.

FIG. 3A is a functional block diagram of the information processing device 200 functioning as a device of the device management server according to the embodiment, and FIG. 3B is a functional block diagram showing an example of a functional constitution of the device 102.

FIG. 4 is a view showing an example of a Web UI for registering a management target device in the device management server 101.

FIG. 5 is a view showing an example of a license code input screen displayed in a UI 216 of the device 102.

FIG. 6 is a flowchart showing an example of master information association change processing in a device management method according to the embodiment.

FIG. 7A is a flowchart showing an example of processing of the device management server 101 which has received a confirmed product name after a license is updated.

FIG. 7B is a flowchart subsequent to that in FIG. 7A.

FIG. 8 is a view showing an example of a Web UI for managing replacement of parts for each device in the device management server 101 according to Third Embodiment.

FIG. 9 is a flowchart showing an example of processing of the device management server 101 which has received a confirmed product name after a license is updated in Third Embodiment.

FIG. 10 is a flowchart showing an example of updating processing of information of parts in the device management method according to Fourth Embodiment.

FIG. 11 is a view showing an example of a Web UI for managing a history of errors for each device in the device management server 101 according to Fifth Embodiment.

FIG. 12 is a flowchart showing an example of processing of redetermining a failure history of a device in the device management method according to Fifth Embodiment.

### DESCRIPTION OF THE EMBODIMENTS

Hereinafter, Hereinafter, with reference to the accompanying drawings, favorable modes of the present invention will be described using Embodiments. In each diagram, the same reference signs are applied to the same members or elements, and duplicate description will be omitted or simplified.

### First Embodiment

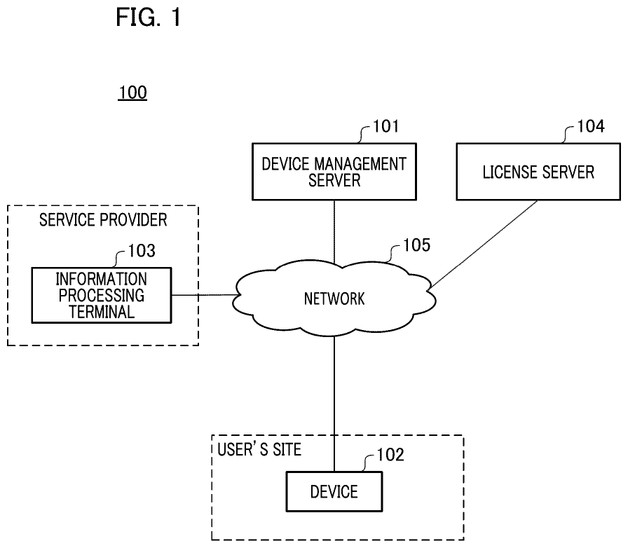

FIG. 1 is a view showing an example of a constitution of a device management system 100 according to an embodiment of the present invention. The device management system 100 is a system in which a device management server 101, a device 102, an information processing terminal 103, a license server 104, and the like are connected via a network 105.

The device management server 101 is a cloud service system, which integrally provides various device management services for managing devices. First Embodiment shows an example in which the device management server 101 operates on one information processing device. However, it may be constituted to include a plurality of information processing devices, and the information processing devices may be constituted to cooperate through communication.

The device 102 is a device installed at a user's site and is managed by the device management server 101. The device 102 is connected to the device management server 101 via the network 105 and transmits settings information of the device 102 and an operational status to the device management server 101.

In First Embodiment, the device is a printing device or a copying device, of which the continuous printing speed or the continuous copying speed can be changed in accordance with a license, for example. In addition, in First Embodiment, the printing speed includes a copying speed.

FIG. 1 shows a view as an example in which there is one device 102 at one user's site. However, the device management server 101 manages one or more devices which are respectively present at one or more user's sites.

The information processing terminal 103 is an information processing terminal used by a person in charge (user) of a service provider performing various kinds of instructions with respect to the device management server 101. A Web browser is installed in the information processing terminal 103, which has a function of operating a Web UI provided by the device management server 101. The information processing terminal 103 may function as a part of the device management server 101 or may be constituted integrally with the device management server 101.

The license server 104 is a system which issues a license code for changing the continuous printing speed (continuous copying speed or the like) of the device. The network 105 is a network such as the Internet. The Web UI provided by the device management server 101 is open to the public on the network such as the Internet, and the device management server 101 can communicate with the device 102 and the information processing terminal 103 via the network 105.

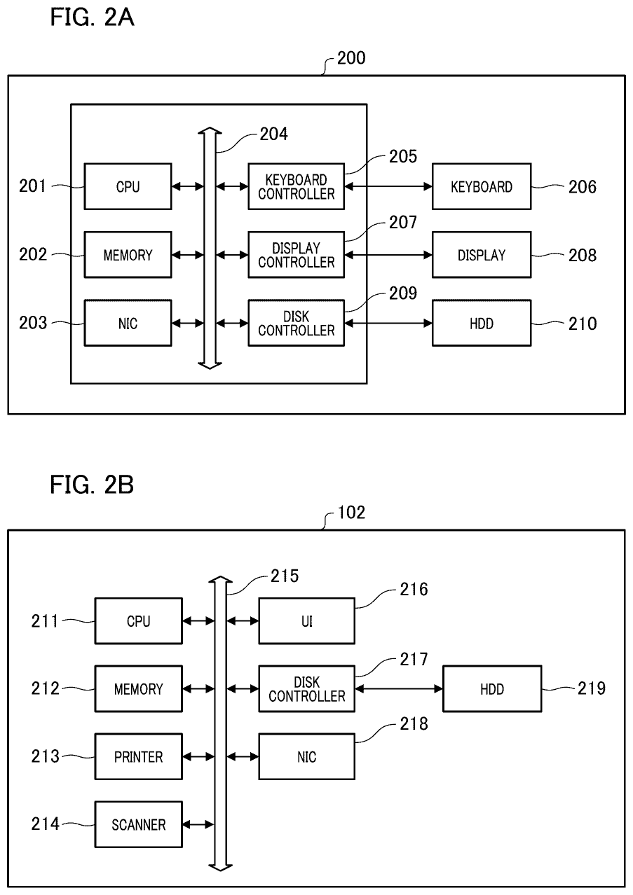

FIG. 2A is a view showing an example of a constitution of hardware of an information processing device 200 functioning as the device management server 101. The information processing device 200 includes a CPU 201 serving as a computer which executes software stored in a hardware disk drive (HDD) 210 that is a storage device. The CPU 201 comprehensively controls each piece of hardware connected to a system bus 204.

The reference sign 202 indicates a memory, which functions as a main memory of the CPU 201, a work area, and the like. The reference sign 203 indicates a network interface card (NIC), which exchanges data bidirectionally with other nodes via the network 105.

The reference sign 205 indicates a keyboard controller for controlling instruction inputs from a keyboard 206 provided in the information processing device. Depending on the role of the information processing device, a constitution not having the keyboard controller 205 and the keyboard 206 may be adopted.

The reference sign 207 indicates a display controller, which controls display of a display module 208 constituted of a liquid crystal display and the like, for example. Depending on the role of the information processing device, a constitution not having the display controller 207 and the display module 208 may be adopted. The reference sign 209 indicates a disk controller, which controls the HDD 210 that is a storage device. The license server 104 has an internal constitution similar to the constitution of the information processing device.

FIG. 2B is a view showing an example of a constitution of hardware of the device 102. The device 102 includes a CPU 211 serving as a computer which executes software stored in an HDD 219 that is a storage device. The CPU 211 controls a printer 213, a scanner 214, and the like connected to a system bus 215.

The reference sign 212 indicates a memory, which functions as a main memory of the CPU 211, a work area, and the like. A touch panel, a button, and the like for operation are arranged in a UI 216, which is used for transferring information input by a device user through the UI 216 to the CPU 211. A disk controller 217 controls access of data to the HDD 219. An NIC 218 exchanges data bidirectionally with other nodes via the network 105.

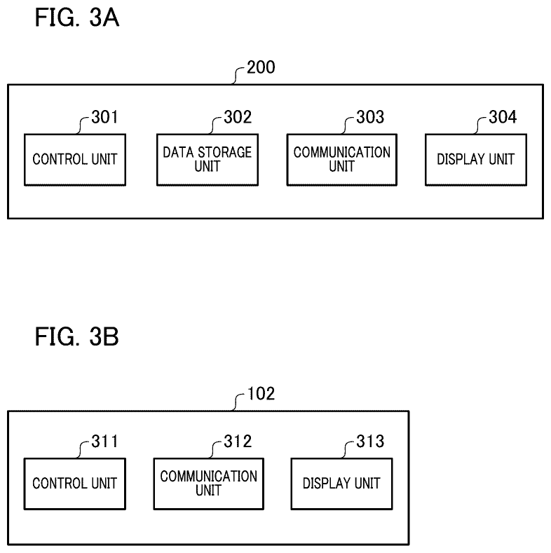

FIG. 3A is a functional block diagram showing an example of a functional constitution of the information processing device 200 functioning as the device management server 101. Some of the functional blocks shown in FIG. 3A are realized by the CPU 201, which serves as a computer included in the information processing device 200, reading out a computer program stored in the HDD 210 serving as a storage medium into the memory 202 and executing it.

However, some or all of them may be realized by hardware. A dedicated circuit (ASIC), a processor (a reconfigurable processor, DSP), or the like can be used as the hardware.

In addition, each of the functional blocks shown in FIG. 3A does not have to be built into the same casing, and they may be constituted by separate devices connected to each other via signal lines. The foregoing description related to FIG. 3A also applies to FIG. 3B in a similar manner.

A control unit 301 is a software module which receives various kinds of processing execution instructions and the like and executes various kinds of processing. A data storage unit 302 is a database constituted by the HDD 210 or the like. As will be described below, the control unit 301 executes a storing step of storing product information of a device and information of consumables used in the device in the data storage unit 302 in association with the device.

A communication unit 303 is a software module for communicating with external systems via the network 105. A display unit 304 is a software module which provides a Web UI allowing an operation of the device management server 101 in response to a request from the information processing terminal 103 or the like.

FIG. 3B is a functional block diagram showing an example of a functional constitution of the device 102. Each unit of the device 102 is realized by the CPU 211 serving as a computer reading out a computer program stored in the HDD 219 into the memory 212 and executing it.

A control unit 311 is a software module which receives various kinds of processing execution instructions from the UI 216 and executes various kinds of processing. A communication unit 312 is a software module for communicating with external systems via the network 105. A display unit 313 displays a UI for the UI 216.

Next, Table 1 is an example of a product master information management table, and the product master information management table is saved in the data storage unit 302 by the control unit 301 of the device management server 101.

The product master information management table has, as product master information, “Product code” and “Product name” uniquely identifying a product, and “Product type” indicating a product type, such as a multifunction machine or a printer. In addition, the product master information management table further has “Color type” indicating whether it is color or monochrome, “Continuous printing speed”, and “Speed license (SL) flag”.

In First Embodiment, the SL flags are flags for distinguishing whether master information thereof indicates a product series, an individual product compatible with the product series, or a product incompatible with the speed license. S is stored for the product series, A is stored for the individual product compatible with the product series, and N is stored for the product incompatible with the speed license.

In the example of Table 1, a product code MA001 is a product series, and it is indicated that MA002 and MA003 are individual products compatible with the product series. In addition, it is indicated that MA004 is defined as a product incompatible with the speed license.

TABLE 1

| | | | | Continuous | |
|---|---|---|---|---|---|
| Product | Product | Product | Color | printing | |
| code | name | type | type | speed | SL flag |
| MA001 | M1-series | Multi- | Monochrome | — | S |
| | | function | | | |
| | | machine | | | |
| MA002 | M1-50 | Multi- | Monochrome | 50 | A |
| | | function | | | |
| | | machine | | | |
| MA003 | M1-70 | Multi- | Monochrome | 70 | A |
| | | function | | | |
| | | machine | | | |
| MA004 | M2 | Multi- | Color | 50 | N |
| | | function | | | |
| | | machine | | | |
| MA005 | M3-series | Multi- | Monochrome | — | S |
| | | function | | | |
| | | machine | | | |
| MA006 | M3-60 | Multi- | Monochrome | 60 | A |
| | | function | | | |
| | | machine | | | |
| MA007 | M3-70 | Multi- | Monochrome | 70 | A |
| | | function | | | |
| | | machine | | | |

Table 2 is an example of a consumables master information management table, which is saved in the data storage unit 302 by the control unit 301 of the device management server 101. The table has, as consumables master information, “Consumables code” and “Consumables name” uniquely identifying consumables, “Color” indicating a color such as black or cyan, “Capacity”, and “Product code” indicating a product for which the consumables are available.

TABLE 2

| Consumables | Consumables | | | |
|---|---|---|---|---|
| code | name | Color | Capacity | Product code |
| CS0011 | C0011 Black | Black | Standard | MA001, |
| | | | | MA002, |
| | | | | MA003 |
| CS0012 | C0012 Black | Black | Large | MA001, |
| | | | capacity | MA002, |
| | | | | MA003 |
| CS0021 | C0021 Black | Black | Standard | MA004 |
| CS0022 | C0022 Black | Black | Large | MA004 |
| | | | capacity | |
| CS0023 | C0023 Yellow | Yellow | Standard | MA004 |
| CS0024 | C0024 Cyan | Cyan | Standard | MA004 |
| CS0025 | C0025 Magenta | Magenta | Standard | MA004 |
| CS0026 | C0026 Black | Black | Standard | MA005, |
| | | | | MA006, |
| | | | | MA007 |
| CS0027 | C0027 Black | Black | Large | MA005, |
| | | | capacity | MA006, |
| | | | | MA007 |

In the example of Table 2, it is indicated that the consumables with the consumables codes CS0011 and CS0012 are registered as consumables available in the products with the product codes MA001, MA002, and MA003. It is indicated that the consumables with CS0021 to CS0025 are registered as consumables available in the product code MA004.

Table 3 is an example of a recommended consumables management table in which recommended consumables are defined with respect to the respective product codes, and which is saved in the data storage unit 302 by the control unit 301 of the device management server 101.

Recommended consumables are registered as single recommended consumables for each color if there are a plurality of kinds of consumables of the same color compatible with each product code. In the example of Table 3, it is indicated that the recommended consumables for MA002 are CS0011.

TABLE 3

| Product code | Color | Consumables code |
|---|---|---|
| MA002 | Black | CS0011 |
| MA003 | Black | CS0012 |
| MA004 | Black | CS0021 |
| MA004 | Yellow | CS0023 |
| MA004 | Cyan | CS0024 |
| MA004 | Magenta | CS0025 |
| MA006 | Black | CS0026 |
| MA007 | Black | CS0027 |

Table 4 is an example of a device management table, which is saved in the data storage unit 302 by the control unit 301 of the device management server 101. The device management table stores, as device information, “Device ID” uniquely identifying a device and “Serial number” assigned for each device when the device is manufactured.

In addition, the table stores, as the device information, “User ID” uniquely identifying a user who owns the device, “Device name”, “IP address”, “Product code” indicating product master information to be associated, and “Consumables code” indicating consumables used in the device.

The device IDs are used by the device management server 101 uniquely identifying and managing devices when the devices are registered. A method of device registration will be described below. In the case of a color machine (color printer), a plurality of consumables for each color are associated and stored in a consumables code field.

In a device with a device ID of D1, MA001 is associated with the product code. That is, the device is in a state of being associated with the product series, and the continuous printing speed is in a state before confirmation. In a device with a device ID of D2, MA002 is associated with the product. Namely, the device is in a state of being associated with the individual product compatible with the product series, the continuous printing speed is in a state after confirmation.

In this manner, in First Embodiment, for example, as shown in Table 4, the data storage unit 302 functions as a storage unit performing a storing step of storing the product information of devices and the information of consumables used in the devices in association with the devices.

In a device with a device ID of D3, MA004 is associated with the product. Namely, it is indicated that the device is associated with the product incompatible with the speed license and it is a speed license incompatible device.

TABLE 4

| Device | Serial | User | Device | | Product | Consumables |
|---|---|---|---|---|---|---|
| ID | number | ID | name | IP address | code | code |
| D1 | D11111 | C1 | Dev 1 | 1.11.11.11 | MA001 | CS0011 |
| D2 | D22222 | C2 | Dev 2 | 1.11.12.12 | MA002 | CS0012 |
| D3 | D33333 | C2 | Dev 3 | 1.12.11.11 | MA004 | CS0021, |
| | | | | | | CS0023, |
| | | | | | | CS0024, |
| | | | | | | CS0025 |

Device registration can be executed in response to an instruction from the information processing terminal 103. That is, in device registration, the display unit 304 of the device management server 101 displays a Web UI for device registration in the information processing terminal 103 in response to an instruction from the information processing terminal 103. Further, it is performed by a person in charge (user) inputting the device information using the information processing terminal 103.

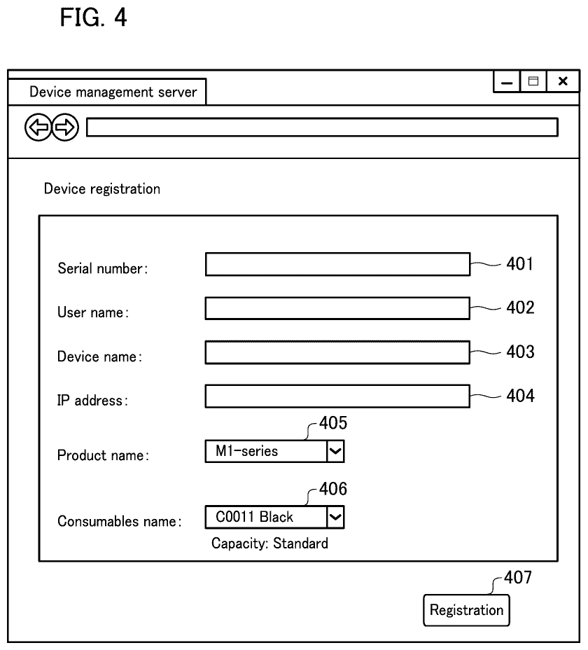

FIG. 4 is a view showing an example of a Web UI for registering a management target device in the device management server 101. A person in charge (user) performing device registration makes a request from the information processing terminal 103 with respect to the device management server 101 to display the Web UI for device registration. The display unit 304 provides the Web UI for device registration in response to the request.

A person in charge (user) inputs information necessary for device registration to the Web UI and presses down a registration button 407. When the registration button 407 is pressed down, the display unit 304 sends the input device information to the control unit 301 and instructs to execute device registration.

The control unit 301 stores (saves) the received device information in the device management table (Table 3). That is, a storing step of storing the product information of devices and the information of consumables used in the devices in the data storage unit 302 in associated with the devices is executed.

As shown in FIG. 4, input items include a serial number 401, a user name 402, a device name 403, an IP address 404, a product name selected from a pull-down list 405, and a consumables name selected from a pull-down list 406. The pull-down list 405 displays a list of product names of product master information registered in the product master information management table (Table 1).

The pull-down list 406 displays consumables names of consumables available in the product selected from the pull-down list 405 in the consumables master information registered in the consumables master information management table (Table 2). For example, if “M1-series” is selected as the product name in the pull-down list 405, the pull-down list 406 can display consumables names “C0011Black” and “C0012Black” as candidates.

When a consumables name is selected from the pull-down list 406, capacity information may also be displayed in parallel as information for checking whether the selection is correct. The product ID corresponding to the selected product name and the consumables ID corresponding to the selected consumables name are registered in the device management table (Table 4).

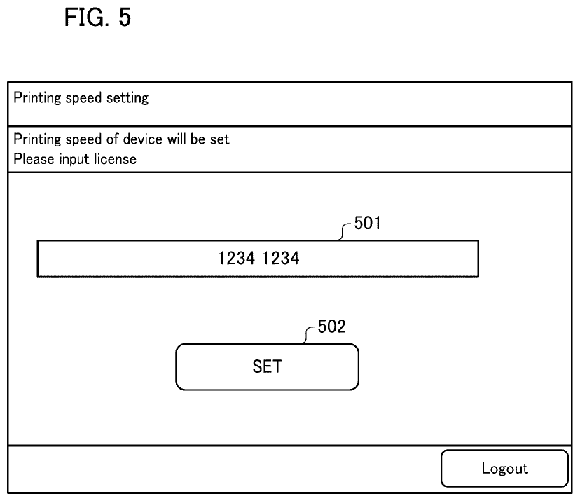

FIG. 5 is a view showing an example of a license code input screen displayed in the UI 216 of the device 102. The license code is issued by the license server 104. The license code is input by operating hard keys of the device, the touch panel, or the like.

A person in charge (user) installing a device inputs the license code determining the continuous printing speed to a license code input field 501 and presses down a setting button 502. Accordingly, the continuous printing speed of the device is determined, and the product is also confirmed. The control unit 311 of the device 102 transmits the confirmed product name to the device management server 101 via the communication unit 312.

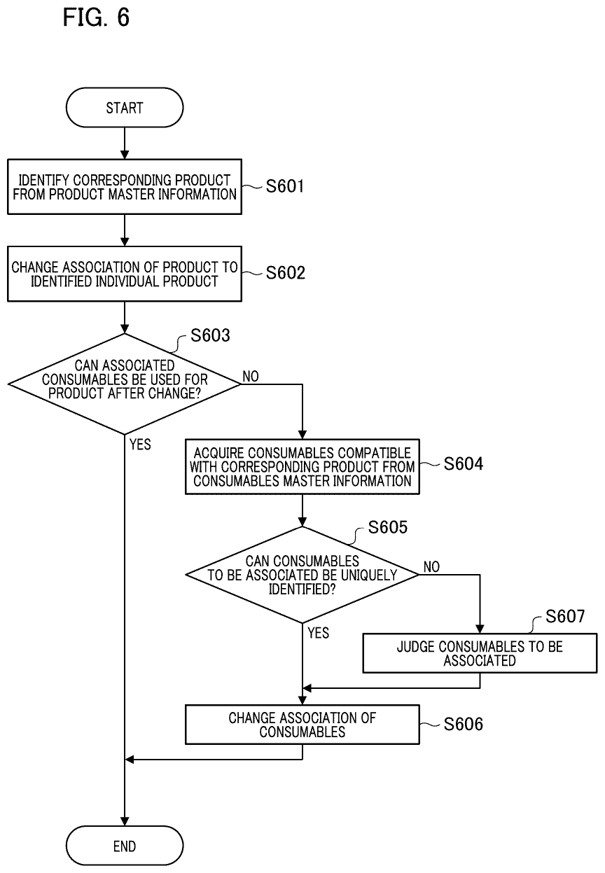

FIG. 6 is a flowchart showing an example of master information association change processing in a device management method according to the embodiment. The diagram shows an example of processing in the device management server 101 which has received a confirmed product name from the device 102 after license authentication is performed in the device 102 and the product name is confirmed.

The operation of each step of the flowchart in FIG. 6 is sequentially performed by the CPU 201 serving as a computer inside the information processing device executing the computer program stored in the memory.

In First Embodiment, it is assumed that the device D1 has been registered in the device management server 101 in advance. That is, it is assumed that the data in the first row in the device management table (Table 4) is registered.

When license authentication is performed in a speed license compatible device, the device notifies the device management server 101 of its own serial number and the product name confirmed by license authentication.

That is, for example, if a license for a continuous printing speed of 50 sheets is input for the device D1, the product name “M1-50” is notified to the device management server 101. Consequently, in Step S601, the device management server 101 which has received a confirmed product name from the device 102 searches for “Product name” in the product master information management table (Table 1) using the received product name and identifies the product to be changed as an individual product.

That is, in Step S601, processing of acquiring information of the individual product compatible with the changed continuous printing speed from the data storage unit 302 is performed on the basis of the changed information of the continuous printing speed received from the device.

Next, in Step S602, the device management server 101 changes the product to be associated with the device to the identified individual product. Specifically, the product code of the device D1 in the device management table (Table 4) is changed to MA002.

Next, in Step S603, the device management server 101 judges whether or not the consumables associated with the device are available in the product after change. In the consumables master information management table (Table 2), the consumables CS0011 associated with the device D1 are also available in the product MA002 after change. In this case, it is determined as Yes in Step S603, and since processing related to consumables is unnecessary, the flow in FIG. 6 ends.

Meanwhile, if the product name confirmed by license authentication for the device D1 is “M3-70”, for example, the device management server 101 changes the product code of the device D1 to MA007 in Step S602 on the basis of Table 1. It is conceivable that “M1-series” of the product series has been associated when the device was registered but it was incorrect and the product series should be “M3-series”.

In the consumables master information management table (Table 2), the consumables CS0011 associated with the device D1 are not compatible with the product code MA007. For this reason, the device management server 101 judges in Step S603 that it is not available. That is, in Step S603, it is determined that the information of the consumables associated with the device are not available in the individual product, and the processing proceeds to Step S604.

In Step S604, the device management server 101 acquires the consumables compatible with the product code MA007 after change from the consumables master information management table (Table 2). According to Table 2, the consumables available for the product code MA007 are CS0026 or CS0027. Next, in Step S605, the device management server 101 judges whether or not the available consumables acquired in Step S604 can be uniquely identified.

In Step S605, if the consumables available for MA007 are only CS0026 and can be uniquely identified, the processing proceeds to Step S606, and the device management server 101 changes the consumables to be associated with the device D1 to CS0026 in Step S606. Thereafter, the flow in FIG. 5 ends.

However, in this case, since there are two available consumables CS0026 and CS0027 which are acquired in Step S604, it is judged as No in Step S605, and the processing proceeds to Step S607. In Step S607, the device management server 101 judges the consumables to be associated with the device D1 from the consumables acquired in Step S604.

In First Embodiment, any of the following methods is adopted as a judgment method. A first judgment method is a method in which recommended consumables are associated with the product code MA007 after change. In the recommended consumables management table (Table 3), the recommended consumables for the product code MA007 are CS0027.

For this reason, in Step S607, CS0027 is selected and associated from two consumables. That is, if there are a plurality of consumables available in the individual product after change, the recommended consumables for the individual product after change are selected as consumables to be reassociated.

A second judgment method is a method in which consumables close to an attribute value of the consumables which have been associated are associated. Here, an example of using the capacity for judgment is shown. The reason for using the capacity for judgment is that when a consumables name is selected from the pull-down list 406 during device registration in the Web UI in FIG. 4, for example, if consumables having a relatively large capacity are selected, it can be predicted that it is desired to select a large capacity although the type of consumables is different.

The capacity of the consumables CS0011 which has been originally associated is “Standard” as shown in Table 2. In addition, in the candidates, CS0026 is “Standard” and CS0027 is “Large capacity”. For this reason, in the second judgment method, it is judged that CS0026 is to be associated. That is, if there are a plurality of consumables available in the individual product after change, consumables to be reassociated are selected on the basis of the attribute of the information of the associated consumables.

A third judgment method is a method in which the consumables which have been used are judged based on the number of printed sheets and the remaining amount of the consumables if the device already has printing results. That is, first, in the device management server 101, information on the number of printed sheets in the device and information on the remaining amount of the consumables are acquired from the device.

For example, it is assumed that 10,000 sheets can be printed in the case of a standard capacity and 30,000 sheets can be printed in the case of a large capacity. If the printing results are 5,000 sheets and the remaining amount of the consumables is 50%, it is judged that the consumables which have been used are consumables having a standard capacity in the third judgment method.

That is, if there are a plurality of consumables available in the individual product after change, as the consumables to be reassociated, the consumables which have been actually used are judged and selected on the basis of the number of printed sheets and the remaining amount of the consumables in the printing results of the device.

The way of employing any of the foregoing judgment methods may be uniquely determined by the system or may be selected by a person in charge (user) in advance. Alternately, it may be judged whether or not to automatically change the association of the consumables, and if it is judged not to perform automatic change, a user may be notified that association needs to be changed.

In the second judgment method, if all the candidate consumables have the same attribute values as a judgment criteria, that is, for example, if all the candidate consumables have a capacity of “Standard”, no judgment can be made. Therefore, first, judgment is made by the second judgment method, and if judgment cannot be made, a plurality of judgment methods may be combined, such as setting the recommended consumables in the first judgment method.

In addition, a plurality of judgment methods may be combined, such as using the third judgment method if there are printing results, and using the first judgment method if there are no printing results.

In Step S607, when the consumables to be associated are judged and determined, in Step S606, the device management server 101 rewrites the consumables code of the device in the device management table (Table 4), and the flow in FIG. 6 ends.

Step S607 and the like function as a changing step (change unit) of acquiring the information of the consumables available in the individual product from the data storage unit and performing change processing for reassociation with the device if the information of the consumables associated with the device is not available in the individual product.

As above, a method in which proper consumables are predicted and association is automatically changed has been described. However, depending on the service provided to a user, there is a need to more accurately set consumables to be used in the device management server 101. For example, if an automatic consumables ordering service is provided, when consumables different from the consumables which are actually used in the device are registered on the service side, improper consumables will be delivered.

Table 5 is an example of a service utilization management table and is saved in the data storage unit 302 by the control unit 301 of the device management server 101. Whether or not to utilize each service provided by the device management server 101 for each user is set. It is assumed that these are set by a person in charge (user) when signing a service contract.

The example of Table 5 shows that a user C1 utilizes a stock management service and a printing results tallying service and a user C2 utilizes a stock management service, an automatic consumables ordering service, and a printing results tallying service. In First Embodiment, utilized services are set on a user basis, but the utilized services may be set on a different basis, such as a device basis.

TABLE 5

| | | Automatic | |
|---|---|---|---|
| | Stock | consumables | Printing results |
| User | management | ordering | tallying |
| C1 | Yes | No | Yes |
| C2 | Yes | Yes | Yes |

In addition, in the judgment processing in Step S607, the device management server 101 may further judge whether or not the device is a target of the automatic consumables ordering service. Further, if it is not a target, consumables predicted by the method described above are associated. Meanwhile, if it is a target, a person in charge (user) may be notified of the fact that settings of the product and the consumables are incorrect and information of the predicted consumables using a communication unit such as an e-mail.

According to First Embodiment, it is possible to provide a device management server capable of associating consumables compatible with a changed continuous printing speed if the continuous printing speed is changed.

### Second Embodiment

In Second Embodiment, an example in which after the continuous printing speed is determined by license authentication, another license authentication is performed again to change the continuous printing speed will be described. Detailed description of constitutions and procedures similar to those of First Embodiment will be omitted.

A case in which a device is used at a low speed in an initial stage and a user desires to change to a high speed in consideration of an actual usage status is conceivable. For example, an example in which a device of the product series “M1-series” is used as the product code MA002, which is a product of 50 sheets per minute, and is changed to the product code MA003, which is a product of 70 sheets per minute, in the middle of the process will be described. It is assumed that the device is the device D2 owned by the user C2 in the second row in the device management table (Table 4).

In the recommended consumables management table (Table 3), the recommended consumables of the product code MA002 are the consumables CS0011 having a standard capacity. Meanwhile, the recommended consumables of the product code MA003 are the consumables CS0012 having a large capacity. This is because consumables having a large capacity are recommended in consideration of the amount of consumption of the consumables since a large number of printed sheets are expected if the product code MA003 (high-speed machine) is used.

However, if the consumables are changed to the recommended consumables for a high-speed machine in accordance with change to a high-speed machine, a problem may occur when the association of the consumables with the device is quickly changed on the device management server 101.

If the device management server 101 provides a consumables stock management service, if there are no consumables having a large capacity which have been newly associated with the device although originally associated consumables having a standard capacity remain in the stock, it is judged to be out of stock.

Moreover, if the automatic consumables ordering service is utilized, consumables may be ordered although there is an available stock. For this reason, in Second Embodiment, the association of the consumables is changed at an appropriate timing.

That is, in the license code input screen (FIG. 5), when a new license code is input, the control unit 311 of the device 102 transmits the product name “M1-70” after change to the device management server 101 via the communication unit 312.

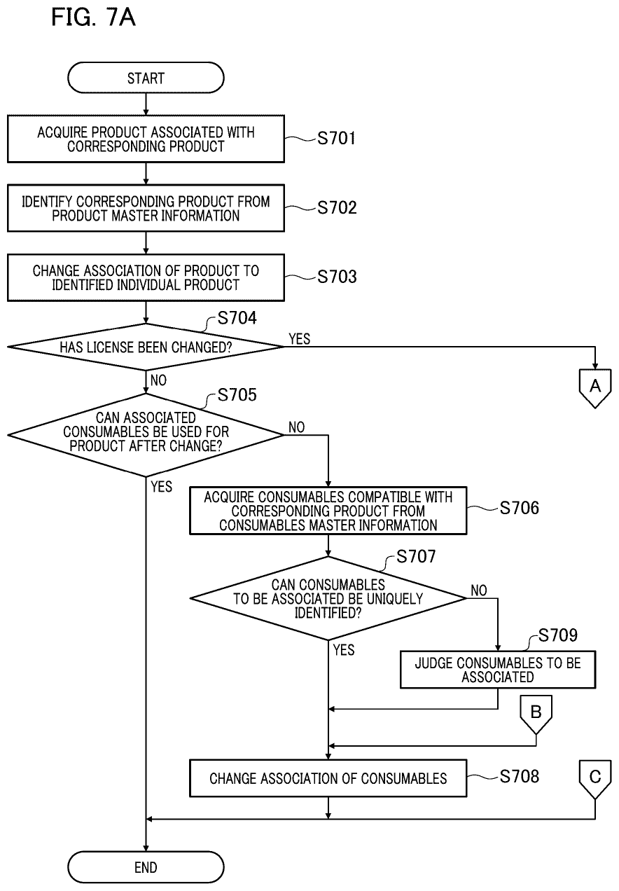

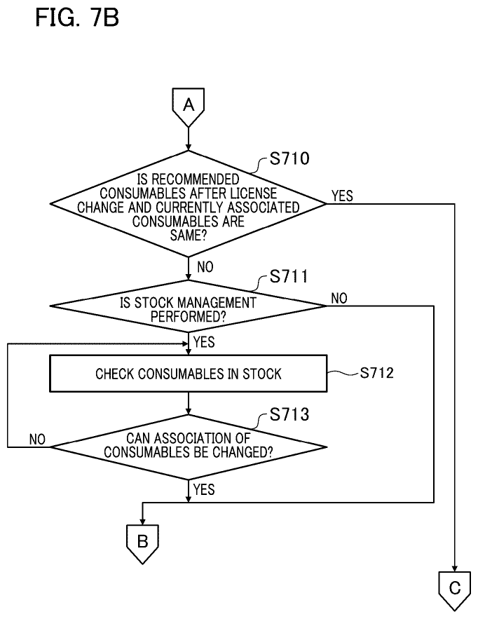

FIG. 7A is a flowchart showing an example of processing of the device management server 101 which has received a confirmed product name after a license is updated, and FIG. 7B is a flowchart subsequent to that in FIG. 7A. The operation of each step of the flowchart in FIGS. 7A and 7B is sequentially performed by the CPU 201 serving as a computer inside the information processing device executing the computer program stored in the memory.

In Step S701, the device management server 101 which has received the product name after change acquires the product associated with the notified device from the device management table (Table 4). In the case of Second Embodiment, MA002 is acquired.

Next, in Step S702, the product after change is identified from the product master information, and the product to be associated with the device is changed to the identified individual product in Step S703. Moreover, in Step S704, the device management server 101 judges whether the current product change is due to license change.

Regarding a judgment method, it is judged based on whether or not the SL flag in the product master information management table (Table 1) is “S”. If the associated product before change is “S”, since the associated product is a product series, it is judged that license authentication is the first time and there is no license change. If it is other than “S”, it is judged that license authentication is the second or subsequent time and there is license change.

As a result of the judgment in Step S704, if there is no license change, the processing proceeds to Step S705. Since Steps S705 to S709 are similar to those in First Embodiment, description will be omitted. In Second Embodiment, in MA002 which is a product before change and has been acquired in Step S701, since the SL flag is not “S”, it is judged in Step S704 that there is license change, and the processing proceeds to Step S710 in FIG. 7B.

In Step S710, the device management server 101 judges whether the recommended consumables for the received product after change and the consumables associated with the device are the same. If they are the same, since there is no need to change the association of the consumables, the flow of FIGS. 7A and 7B ends.

In Second Embodiment, since the recommended consumables for the product code MA003 after change are CS0012 and the consumables associated with the device are CS0011, it is judged as No in Step S710, and the processing proceeds to Step S711.

In Step S711, the device management server 101 judges whether the device performs stock management, that is, whether the device utilizes the stock management service. As a result of the judgment in Step S711, if it does not perform stock management, the processing proceeds to Step S708, and after the association of the consumables is changed to that of the recommended consumables for the product after change, the flow of FIGS. 7A and 7B ends.

In the case of Second Embodiment, in Step S711, based on the service utilization management table (Table 5), it is judged that the user C2 utilizes the stock management service, and the processing proceeds to Step S712. In Step S712, the device management server 101 checks for the remaining number of the consumables in stock which is currently associated with the user in a consumables stock management table.

Table 6 is an example of the consumables stock management table and is saved in the data storage unit 302 by the control unit 301 of the device management server 101. “Consumables code”, “Remaining number”, and “Remaining number for automatic ordering” if the automatic ordering service of the consumables are utilized, are stored for each user.

The example of Table 6 indicates that the user C1 has three pieces of CS0011 in stock and does not utilize the automatic ordering service. For example, it is indicated that the user C2 has five pieces of CS0011 in stock and automatic ordering is performed by the automatic ordering service when two pieces remain in stock.

TABLE 6

| | Consumables | Remaining | Remaining number for |
|---|---|---|---|
| User | code | number | automatic ordering |
| C1 | CS0011 | 3 | — |
| C2 | CS0011 | 5 | 2 |
| C2 | CS0021 | 5 | 2 |
| C2 | CS0023 | 3 | 1 |
| C2 | CS0024 | 3 | 1 |
| C2 | CS0025 | 3 | 1 |

In Second Embodiment, the remaining number of the consumables CS0011 in stock for the user C2 is 5. In Step S713, the device management server 101 judges whether the association of the consumables can be changed. Regarding the judgment method, any of the following judgment methods A and B is used.

The judgment method A is a method of performing judgment based on whether or not there is a stock. If the remaining number of the stock is zero, it is judged that the association can be changed. If there is even one piece in stock, it is judged that the association cannot be changed in order to continuously use the currently associated consumables. Accordingly, it is possible to prevent incorrect judgment that there is no stock because there are no consumables after change in stock although there is a stock.

If automatic consumables ordering service is being utilized, the following judgment method B may be used. In the judgment method B, judgment is performed based on whether or not the remaining number has decreased to the remaining number for automatic ordering. The remaining number of the consumables CS0011 in stock for the user C2 is 5, and the remaining number for automatic ordering is 2.

Namely, it has not decreased to the remaining number for automatic ordering. In this case, it is judged that the association cannot be changed. Accordingly, although there is a stock, it is possible to prevent the consumables after change from being incorrectly ordered.

If it is judged in Step S713 that the association cannot be changed, the device management server 101 performs the processing of Step S712 regularly or if the number of pieces in stock varies and performs rechecking whether or not the association can be changed.

If it is judged in Step S713 that the association can be changed, the device management server 101 changes the association of the consumables to that of the recommended consumables for the product after change in Step S708, and the flow of FIGS. 7A and 7B ends.

In this manner, in Second Embodiment, in Steps S704 and S710 to S713, it is judged from the received changed information whether or not the change processing is possible on the basis of the change history of the continuous printing speed (history of whether or not license authentication is the second or subsequent time).

In Second Embodiment, an example in which if the associated consumables differ from the recommended consumables for the product after change, it is changed to the recommended consumables has been described. However, a constitution capable of selecting whether or not to change to the recommended consumables may be adopted.

For example, when the license code is input, the UI is constituted so as to be able to additionally select “Whether or not to change if the recommended consumables differ”, and the device management server 101 is also notified of the information.

If the device management server 101 receives that there is no change to the recommended consumables in the case of the license change, the association of the consumables is not changed. In addition, in Second Embodiment, a case in which the continuous printing speed is permanently changed in accordance with the usage status has been described. However, a case in which it is desired to temporarily change the continuous printing speed is also conceivable.

For example, a low speed is not a problem at a normal time because the printing amount is not large. However, in the case of a device usage status in which the printing amount increases temporarily during busy periods or the like, there is a demand for a temporary change to a high speed.

It is generally conceivable that the license for the higher continuous printing speed becomes more expensive. In such a case, if the device can be made faster temporarily by purchasing a time-limited license instead of permanent license change, it is not a waste of money for a user. In such a case, if the association between the product and the consumables is changed by changing the license, there may be a probability of occurrence of inconvenience in providing the service of the device management server 101.

In the case in which the device management server 101 provides a tallying report service or the like, there is concern that the product and the consumables may be changed temporarily and they may quickly return to the original state so that the tallying report may become difficult to ascertain.

Generally, a device tallying report service reports a list of devices owned by the user, tallying results of the printing results on a monthly basis or a yearly basis, and the like to a user. If reports of the tallying results are provided for each product kind on a yearly basis, it is conceivable that an annual report becomes complicated, such as even the same device is tallied up as a different product only for a certain month.

In addition, since the product is changed temporarily, even if the recommended consumables for the product after change differ from the consumables being used, it is expected to be judged that the change is unnecessary. For example, even if a high-speed machine is set temporarily, there is no need to change to a large capacity of the recommended consumables for a high-speed machine, and it is conceivable that standard-capacity consumables in stock will be sufficient.

If the continuous printing speed is changed temporarily by a time-limited license, although the device itself operates as a product after change, the product and the consumables may not be changed on the device management server 101 side. That is, if it is judged from the received changed information that the change in the continuous printing speed is temporary, the change processing may not be performed.

In this case, at the time of license authentication, the device 102 also notifies the device management server 101 of the input license information in addition to the serial number and the product name of itself. The device management server 101 communicates with the license server 104 to inquire regarding the kind of the license information.

The license server 104 replies with whether the license is a permanent license or a time-limited license. In the case of a time-limited license, the device management server 101 does not perform the change processing for the association between the product and the consumables.

### Third Embodiment

In Third Embodiment, an example in which a scheduled replacement date of parts such as consumables components is updated when the continuous printing speed is determined and the product name is changed by license authentication in the device management server which manages devices having a changeable continuous printing speed will be described. Detailed description of constitutions and procedures similar to those of First Embodiment and Second Embodiment will be omitted.

Part master information is a kind of master information for management of information of a device. The part master information defines a component constituting the instrument. Examples of parts include a transportation roller for transporting paper during printing, a stapler performing stapling, and a collected toner container storing toner waste generated during printing.

TABLE 7

| Product | Part | | | |
|---|---|---|---|---|
| code | code | Part name | Part type | Lifespan |
| MA001 | PRL001 | Transportation | Transportation | 500 |
| | | roller | roller | |
| | | 001 | | |
| MA001 | PST001 | Stapler 001 | Stapler | 500 |
| MA001 | PWT001 | Collected toner | Collected toner | 300 |
| | | container 001 | container | |
| MA002 | PRL001 | Transportation | Transportation | 500 |
| | | roller | roller | |
| | | 001 | | |
| MA002 | PST001 | Stapler 001 | Stapler | 500 |
| MA002 | PWT001 | Collected toner | Collected toner | 300 |
| | | container 001 | container | |
| MA003 | PRL001 | Transportation | Transportation | 400 |
| | | roller | roller | |
| | | 001 | | |
| MA003 | PST001 | Stapler 001 | Stapler | 500 |
| MA003 | PWT001 | Collected toner | Collected toner | 200 |
| | | container 001 | container | |
| MA004 | PRL002 | Transportation | Transportation | 500 |
| | | roller | roller | |
| | | 002 | | |
| MA004 | PST002 | Stapler 002 | Stapler | 500 |
| MA004 | PWT002 | Collected toner | Collected toner | 300 |
| | | container 002 | container | |

Table 7 is an example of a part master information management table and is saved in the data storage unit 302 by the control unit 301 of the device management server 101. In the part master information management table, information of parts constituting a product is registered for each product code. Parts differ for each unit of device hardware. For example, it is indicated that the transportation rollers for the product codes MA001, MA002, and MA003 of the same hardware is PRL001 and the transportation roller for the product code MA004 is PRL002.

The part master information includes “Part code”, “Part name”, “Part type”, and “Lifespan” uniquely identifying a part. Parts have a lifespan due to wear or the like. In the case of the same hardware, there is a case in which although the part itself is common, the expected lifespan may differ depending on the continuous printing speed, such as a case in which the higher the continuous printing speed, the faster the wear.

In Third Embodiment, the unit of the lifespan is the number of days. The unit may not be the number of days, and the number of printed sheets or the number of times may be adopted as the unit depending on the part type. For example, the number of printed sheets may be adopted as the unit for the transportation roller and the collected toner container, and the number of times may be adopted as the unit for the stapler.

In the example of Table 7, the lifespan of the part of PRL001 is set to 500 days for the product codes MA001 and MA002 and is set to 400 days for MA003.

MA001 is a product in a series in which the continuous printing speed is not confirmed. However, the same lifespan as MA002 which is the lowest speed within the series is set on the premise that it is operated at the lowest speed before license authentication and on the premise that it is operated at lowest speed before license confirmation.

Table 8 is an example of a part replacement management table and is saved in the data storage unit 302 by the control unit 301 of the device management server 101.

TABLE 8

| Device | Product | | Replacement | Lifespan | Recommended | Scheduled |
|---|---|---|---|---|---|---|
| ID | code | Part code | date | expiration date | replacement date | replacement date |
| D1 | MA003 | PRL001 | Mar. 1, 2024 | Apr. 10, 2025 | Apr. 3, 2025 | Apr. 5, 2025 |
| D1 | MA003 | PST001 | Nov. 27, 2023 | Apr. 10, 2025 | Apr. 3, 2025 | Apr. 5, 2025 |
| D1 | MA003 | PWT001 | Sep. 17, 2024 | Apr. 5, 2025 | Apr. 3, 2025 | Apr. 5, 2025 |
| D2 | MA002 | PRL001 | Dec. 27, 2023 | May 10, 2025 | May 8, 2025 | May 8, 2025 |
| D2 | MA002 | PST001 | Dec. 27, 2023 | May 10, 2025 | May 8, 2025 | May 8, 2025 |
| D2 | MA002 | PWT001 | Jul. 14, 2024 | May 10, 2025 | Mar. 8, 2025 | Mar. 8, 2025 |

In the part replacement management table of Table 8, the scheduled replacement date of each part is registered for each device. The control unit 301 of the device management server 101 calculates a lifespan expiration date from the part replacement date and the lifespan in the part master information management table of Table 7. The first replacement date is a device installation date.

The control unit 301 of the device management server 101 sets the scheduled replacement dates of parts whose lifespan expiration date is within a certain threshold to the same date starting with the earliest lifespan expiration date among the parts for the same device and registers them as recommended replacement dates.

In the example of Table 8, with the threshold set to ten days, PRL001 and PST001 which are within ten days from Apr. 5, 2025 of PWT001 having the earliest lifespan expiration date among the parts for the device D1 will be replaced on the same date, and the recommended replacement date is two days before the lifespan expiration date. The method of registering the scheduled replacement date will be described below.

Regarding calculation of the scheduled replacement date if the unit of the lifespan is the number of sheets or the number of times, for example, the numbers of days after the same parts for the device have been replaced in the past are retained in the data storage unit 302 in advance, and the lifespan expiration date is calculated using the average number of days for replacement. In Third Embodiment, the recommended replacement date is calculated for each device. However, if the same user is using a plurality of devices, the recommended replacement date may be calculated for all the devices used by the user.

In this manner, in Third Embodiment, for example, as shown in Tables 7 and 8, the data storage unit 302 functions as a storage unit performing a storing step of storing the product information of devices and information of parts such as lifespan information of parts constituting the devices in association with the devices.

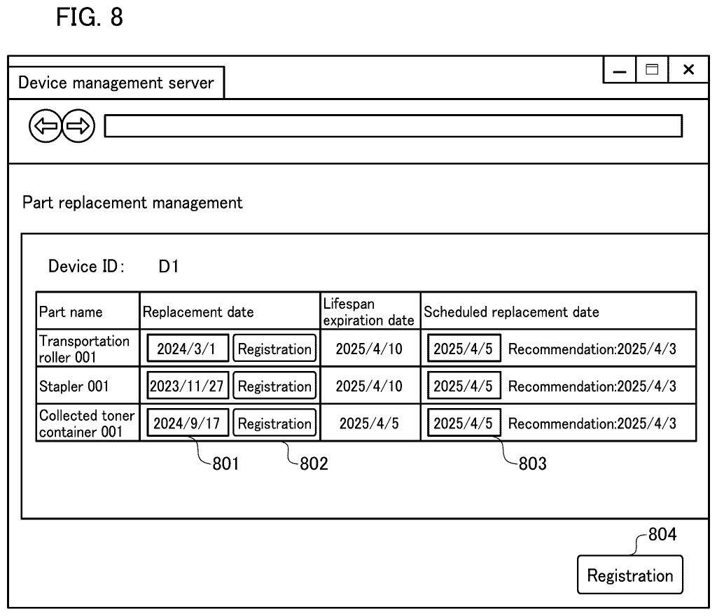

FIG. 8 is a view showing an example of a Web UI for managing replacement of parts for each device in the device management server 101 according to Third Embodiment. A person in charge (user) of managing replacement of parts designates a particular device and makes a request to the device management server 101 from the information processing terminal 103 to display a Web UI for part replacement management. The display unit 304 provides the Web UI for part replacement management in response to the request.

The display unit 304 makes a request to the control unit 301 to acquire data to be displayed in the Web UI. The control unit 301 acquires information of parts in the part replacement management table (Table 8) stored in the data storage unit 302. If the device D1 is designated, information of parts whose device ID is D1 is acquired and transmitted to the display unit 304.

The display unit 304 displays the part name, the replacement date, the lifespan expiration date, the scheduled replacement date, and the recommended replacement date which have been acquired for each part.

When a part is replaced, a person in charge (user) inputs a replacement date 801 and presses down a registration button 802.

When the registration button 802 is pressed down, the display unit 304 sends the device ID, the part ID, and the replacement date 801 to the control unit 301 and instructs it to calculate the lifespan expiration date and the recommended replacement date.

The control unit 301 executes a storing step of calculating the lifespan expiration date and the recommended replacement date and storing them in the data storage unit 302 together with the replacement date received from the part replacement management table (Table 8).

The control unit 301 transmits the calculated results to the display unit 304. The display unit 304 updates and displays the lifespan expiration date and the recommended replacement date which have been received.

A person in charge (user) checks for the recommended replacement date, inputs a scheduled replacement date 803 of each part, and presses down a registration button 804.

When the registration button 804 is pressed down, the display unit 304 sends the input scheduled replacement date to the control unit 301 and instructs it to update the data.

The control unit 301 executes a storing step of storing the received scheduled replacement date of each part in the part replacement management table (Table 8).

In Third Embodiment, an example in which a person in charge (user) inputs a replacement date using a Web UI has been described. However, the lifespan expiration date and the recommended replacement date may be calculated by detecting replacement of a part on a device side and send it to the device management server 101.

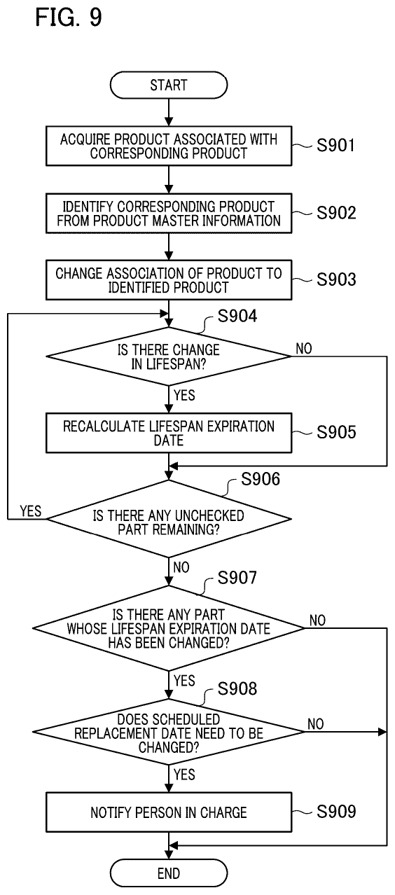

FIG. 9 is a flowchart showing an example of processing of the device management server 101 which has received a confirmed product name after a license is updated in Third Embodiment. The operation of each step of the flowchart in FIG. 9 is sequentially performed by the CPU 201 serving as a computer inside the information processing device executing the computer program stored in the memory.

An example in which a device of the product series “M1-series” is used as the product code MA002, which is a product of 50 sheets per minute, and is changed to the product code MA003, which is a product of 70 sheets per minute, in the middle of the process will be described. The processing from Steps S901 to S903 is similar to the processing from each of S701 to S703 in FIG. 7.

Next, in Step S904, the device management server 101 judges whether there has been a change in the recommended lifespan of the part for each part.

The judgment method compares the lifespan of the part for the product code MA002 before change and the lifespan of the part for the same part code as the product code MA003 after change from the part master information management table (Table 7).

In the case of PRL001, since the lifespan is 500 days in the case of being used for MA002 and the lifespan is 400 days in the case of being used for MA003, it is judged that there is a change in the lifespan.

In the case of PWT001, since the lifespan is the same 300 days even if it is used for MA002 and even if it is used for MA003, it is judged that there is no change in the lifespan.

As a result of the judgment in Step S904, if there is no change the lifespan, the processing proceeds to Step S906. If there is a change in the lifespan, the processing proceeds to Step S905.

In Step S905, the device management server 101 recalculates the lifespan expiration date and writes the results as the lifespan expiration date in the part replacement management table (Table 8).

In Step S906, it is determined whether or not there remains any unchecked part. If checking of the lifespan expiration dates of all parts has been completed, the processing proceeds to Step S907, and if it is determined as Yes in Step S906, the processing returns to Step S904.

In Step S907, the device management server 101 judges whether or not there is any part whose lifespan expiration date has been changed.

As a result of the judgment in Step S907, if there is not even one part whose lifespan expiration date has been changed, the processing flow in FIG. 9 ends.

If there is a part whose lifespan expiration date has been changed, in Step S908, it is judged whether the scheduled replacement date needs to be changed. For this reason, the device management server 101 performs recalculation of the recommended replacement date by the method described above in the description of Table 8.

Next, the recommended replacement date and the set scheduled replacement date are compared, and if the recommended replacement date is earlier than the set scheduled replacement date, it is judged that the scheduled replacement date needs to be changed. This is because there is a probability that the part will reach the end of the lifespan on the set scheduled replacement date.

In addition, if the recommended replacement date is a date earlier than the set scheduled replacement date by a threshold or longer, it is judged that the scheduled replacement date needs to be changed. For example, the threshold is 20 days. This is to prevent the waste of replacement when there still remains a lot of lifespan on the set scheduled replacement date.

In addition, the reason for providing a threshold is that, for example, it is desirable not to change the schedule as much as possible if an appointment for the date of visit for replacement of a part at a user's site has been made in advance. If it is determined as No in Step S908, that is, if it is judged that the scheduled replacement date does not need to be changed, the processing flow in FIG. 9 ends.

If it is determined as Yes in Step S908, that is, if it is judged that the scheduled replacement date needs to be changed, the device management server 101 notifies person in charge (user) in Step S909. The notification is issued by sending an e-mail or the like to an e-mail address set in advance. Thereafter, the processing flow in FIG. 9 ends.

Here, Steps S905 and S908 function as a recalculating step (recalculation unit) in Third Embodiment. In addition, in the recalculating step, the lifespan of a part associated with the individual product compatible with changed the continuous printing speed is acquired from the storage unit on the basis of the changed information of the continuous printing speed received from the device. Further, if the lifespan of the part associated with the product information after change differs from that before change, the lifespan expiration date and the recommended replacement date are recalculated.

### Fourth Embodiment

In Fourth Embodiment, an example in which a part associated with the device is updated in the part replacement management table (Table 8) if a product has been incorrectly associated when a device is registered will be described. Detailed description of constitutions and procedures similar to those of First Embodiment to Third Embodiment will be omitted.

Table 9 is an example of the product master information management table used in Fourth Embodiment. Table 9 has “Series ID” uniquely identifying the product series as the product master information.

TABLE 9

| | | | | | Continuous | |
|---|---|---|---|---|---|---|
| Product | Product | Series | | | printing | |
| code | name | ID | Product type | Color type | speed | SL flag |
| MA001 | M1-series | M1 | Multifunction | Monochrome | — | S |
| | | | machine | | | |
| MA002 | M1-50 | M1 | Multifunction | Monochrome | 50 | A |
| | | | machine | | | |
| MA003 | M1-70 | M1 | Multifunction | Monochrome | 70 | A |
| | | | machine | | | |
| MA004 | M2 | M2 | Multifunction | Color | 50 | N |
| | | | machine | | | |
| MA005 | M3-series | M3 | Multifunction | Monochrome | — | S |
| | | | machine | | | |
| MA006 | M3-60 | M3 | Multifunction | Monochrome | 60 | A |
| | | | machine | | | |
| MA007 | M3-70 | M3 | Multifunction | Monochrome | 70 | A |
| | | | machine | | | |

In addition, in the example of Table 9, the product codes MA001, MA002, and MA003 have the same series ID “M1”, which indicates that they are in the same product series, that is, they have the same hardware.

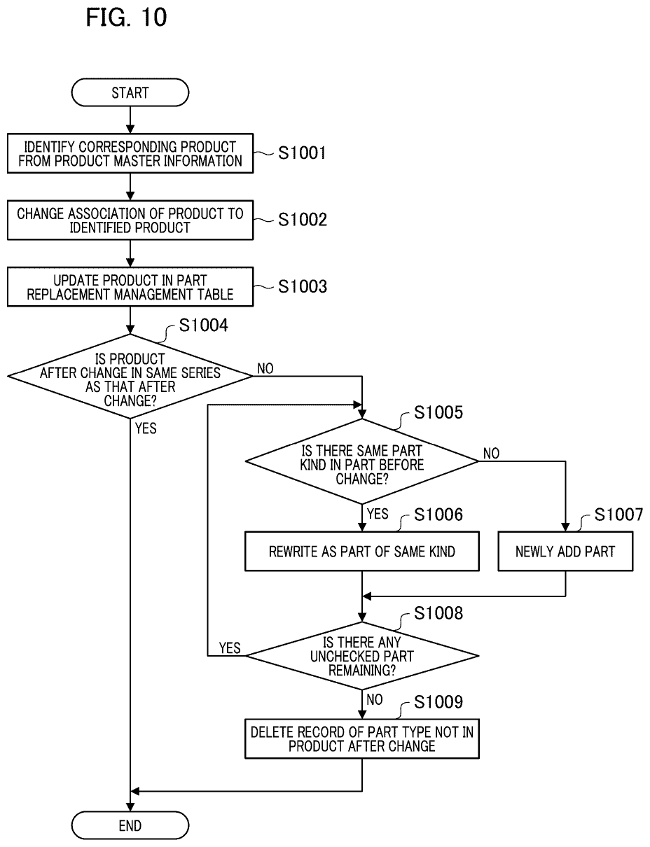

FIG. 10 is a flowchart showing an example of updating processing of information of parts in the device management method according to Fourth Embodiment and shows an example of updating processing in which the device management server 101 which has received a confirmed product name updates the information of a part associated with a device. The operation of each step of the flowchart in FIG. 10 is sequentially performed by the CPU 201 serving as a computer inside the information processing device executing the computer program stored in the memory.

In Step S1001, processing of acquiring information of the individual product compatible with the changed continuous printing speed from the data storage unit 302 is performed on the basis of the changed information of the continuous printing speed received from the device.

Next, in Step S1002, the device management server 101 changes the product to be associated with the device to the identified individual product.

Next, in Step S1003, the device management server 101 rewrites the product code corresponding to the device in the part replacement management table (Table 8) to the product code after change.

Next, in Step S1004, the device management server 101 judges whether or not the products before and after change are in the same series.

If the original product is MA001 and the product after updating is MA003, since the series IDs are the same, it is judged that they are in the same series. The same series means that the hardware is the same, and it is judged that the parts are also the same. The updating processing of parts associated with the device ends. That is, the processing flow in FIG. 10 ends.

If the original product is MA001 and the product after updating is MA007, since the series IDs differ, it is judged in Step S1004 that they are not in the same series. A case in which an incorrect “M1-series” has been associated although “M3-series” should have been associated properly when a device is registered corresponds to this. If the series differs, the part differs.

If it is judged in Step S1004 that they are not in the same series, the processing proceeds to Step S1005. In Step S1005, the device management server 101 acquires the information of the part compatible with the product after updating from the part master information management table (Table 7). Further, in comparison with the part compatible with the device in the part replacement management table (Table 8), it is judged whether or not there is a part of the same part kind.

In Step S1005, if it is determined as Yes, that is, if there is a part of the same part kind, in Step S1006, the part code is rewritten as the part compatible with the product after updating.

In Step S1005, if it is determined as No, that is, if there is no part of the same part kind, in Step S1007, a new record is added to the part replacement management table (Table 8). At this time, the replacement date is set to the date on which the product name is received.

In Steps S1006 and S1007, the information of the part constituting the individual product compatible with the changed continuous printing speed is acquired from the storage unit on the basis of the changed information of the continuous printing speed received from the device. Further, it also functions as the changing step (change unit) of performing the change processing for reassociation with the device.

In addition, in Step S1008, it is determined whether or not any unchecked part remains, and if it is determined as Yes, the processing returns to Step S1005. If it is determined as No, that is, if checking of all parts compatible with the product after change has been completed, the processing proceeds to Step S1009.

In Step S1009, the device management server 101 deletes records of parts of the part type which are not present in the product after change from the parts of the device in the part replacement management table (Table 8), and then the processing flow in FIG. 10 ends.

After the processing flow in FIG. 10 has ended, replacement of parts can be managed with respect to the parts associated with proper products by recalculating the lifespan expiration date and the recommended replacement date of each part through a processing flow similar to the processing flow in FIG. 9 of Third Embodiment.

### Fifth Embodiment

In Fifth Embodiment, an example in which a method of handling errors which have occurred in the device in the past is reviewed if a product has been incorrectly associated when a device is registered will be described. Detailed description of constitutions and procedures similar to those of First Embodiment to Fourth Embodiment will be omitted.

Error code master information is a kind of master information for management of information of a device. The error code master information defines the content of errors occurring in the device and the handling method.

Table 10 is an example of an error code master information management table and is saved in the data storage unit 302 by the control unit 301 of the device management server 101. In the error code master information management table, information of errors having a probability of occurrence in the product is registered for each product code.

TABLE 10

| Product | Error | | |
|---|---|---|---|
| code | code | Error content | Dispatch |
| MA002 | E001 | HDD error \| device restart | Unnecessary |
| MA002 | E002 | | Unnecessary |
| MA002 | E003 | Basic error \| replacement | Unnecessary |
| MA005 | E101 | | Unnecessary |
| MA005 | E102 | | Unnecessary |
| MA005 | E003 | Basic error \| replacement | Necessary |

Errors occurring in devices differ for each unit of device hardware. When the constituting part differs, errors having a probability of occurrence in each part may differ. In addition, even in the case of similar errors, the handling method may differ, such as a case in which a user himself/herself can handle it depending on the hardware constitution and a case in which it is difficult for a user himself/herself to handle it and a serviceman needs to be dispatched.

The error code master information has “Error code”, “Error content”, and “Dispatch” indicating whether or not a serviceman needs to be dispatched.

Table 11 is an example of an error history management table and is saved in the data storage unit 302 by the control unit 301 of the device management server 101. In the error history management table, the history of errors which have occurred for each device is registered.

In Fifth Embodiment, for example, as shown in Tables 10 and 11, the data storage unit 302 functions as a storage unit performing a storing step of storing the product information of devices, information of errors having a probability of occurrence in the devices, and the history of errors having occurred in the devices.

TABLE 11

| | Error | Date of | Date of | Dispatch |
|---|---|---|---|---|
| Device ID | code | occurrence | termination | result |
| D1 | E001 | Jul. 1, 2024 | Jul. 1, 2024 | No |
| D2 | E101 | Aug. 1, 2024 | Aug. 2, 2024 | No |
| D1 | E003 | Aug. 10, 2023 | Aug. 11, 2023 | Yes |
| D1 | E001 | Aug. 30, 2024 | | |

If the control unit 311 of the device 102 detects an error which has occurred in itself, the error code is transmitted to the device management server 101 via the communication unit 312. When the communication unit 303 of the device management server 101 receives communication from a device, the received data is sent to the control unit 301, and the control unit 301 stores it in the data storage unit 302.

The information of the history of errors has “Device ID”, “Error code”, “Date of occurrence”, “Date of termination”, and “Dispatch result” indicating whether or not a serviceman has actually been dispatched.

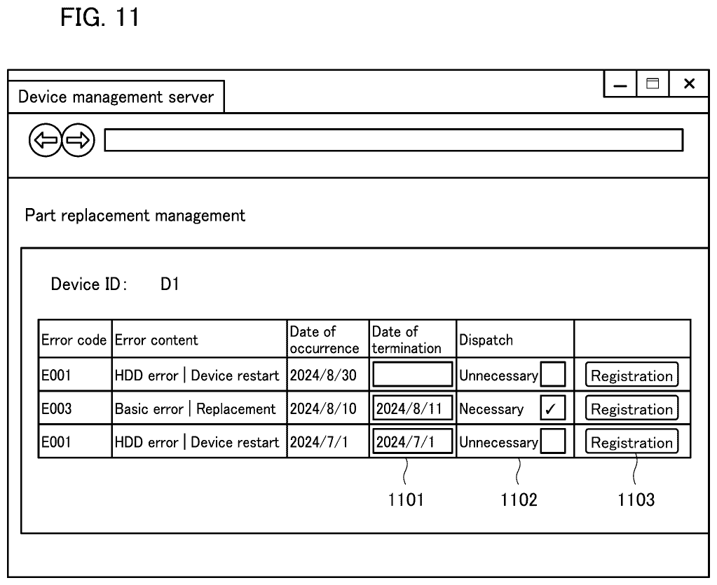

FIG. 11 is a view showing an example of a Web UI for managing a history of errors for each device in the device management server 101 according to Fifth Embodiment. A person in charge (user) coping with an error of a device designates a particular device with respect to the device management server 101 from the information processing terminal 103 and makes a request to display the Web UI for managing the history of errors. The display unit 304 provides the Web UI for managing the history of errors in response to the request.

The display unit 304 makes a request to the control unit 301 to acquire data to be displayed in the Web UI. The control unit 301 acquires information of the history of errors in the error history management table (Table 11) stored in the data storage unit 302. If the device D1 is designated, the history of errors whose device ID is D1 is acquired. In addition, information of errors corresponding to the acquired error code is acquired from the error code master information management table (Table 10). The control unit 301 transmits the acquired data to the display unit 304.

The display unit 304 displays the error code, the date of occurrence, and the date of termination acquired from the error history management table for each history of errors. If the dispatch result is “Yes”, a checkbox 1102 in the field of Dispatch is displayed in a checked state. In addition, the error content corresponding to the error code and whether dispatch is necessary or not acquired from the error code master information management table (Table 10) are displayed.

When a person in charge (user) has coped with an error, he/she inputs a date of termination 1101, inputs the checkbox 1102 to check whether or not dispatch has been performed, and presses down a registration button 1103.

When the registration button 1103 is pressed down, the display unit 304 transmits the input data to the control unit 301.

The control unit 301 executes a storing step of storing the received data in the error history management table (Table 11).

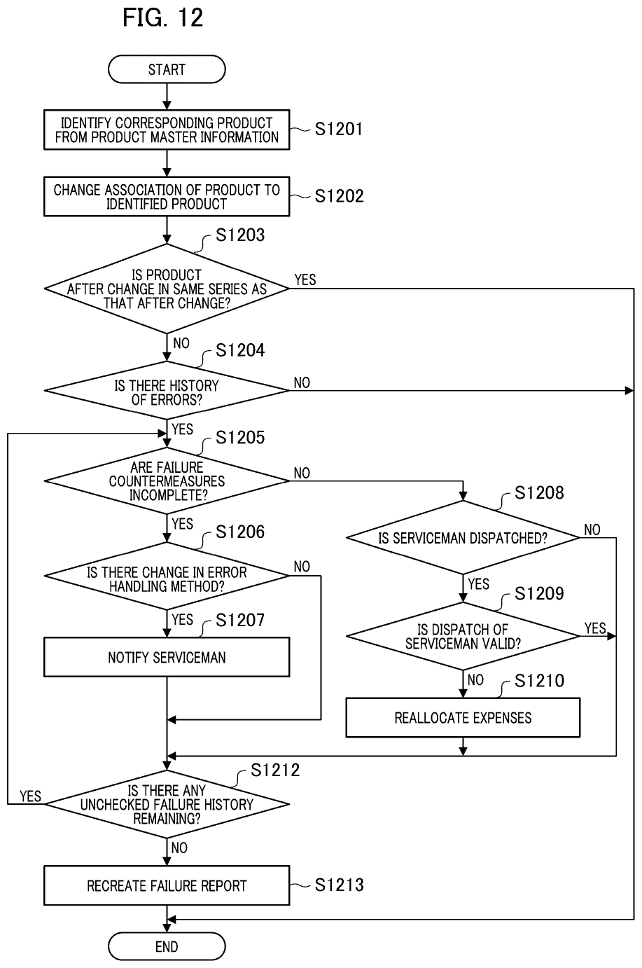

FIG. 12 is a flowchart showing an example of processing of redetermining a failure history of a device in the device management method according to Fifth Embodiment and shows an example of processing in which the device management server 101 which has received a confirmed product name redetermines the failure history of a device. The operation of each step of the flowchart in FIG. 12 is sequentially performed by the CPU 201 serving as a computer inside the information processing device executing the computer program stored in the memory.

In Step S1201, processing of acquiring information of the individual product compatible with the changed continuous printing speed from the data storage unit 302 on the basis of the changed information of the continuous printing speed received from the device is performed.

Next, in Step S1202, the device management server 101 changes the product to be associated with the device to the identified individual product.

Next, in Step S1203, the device management server 101 judges whether or not the products before and after change are in the same series. That is, it is judged whether or not there is a change in the information of errors having a probability of occurrence in the devices on the basis of the changed information of the continuous printing speed received from the device.

If it is determined as Yes in Step S1203, the processing flow in FIG. 12 ends. If it is determined as No in Step S1203, that is, if it is determined that they are not in the same series, the processing proceeds to Step S1204.

In Step S1204, the device management server 101 searches for the error history management table (Table 11) and determines whether or not there is a history of errors of the device. If it is determined as No in Step S1204, that is, if there is no history of errors, the processing flow in FIG. 12 ends.

If it is determined as Yes in Step S1204, that is, if there is a history of errors, the processing proceeds to Step S1205.

In Step S1205, the device management server 101 judges whether or not the failure countermeasures against the error are incomplete. That is, if there is no value in “Date of termination” in the error history management table (Table 11), it is judged that it is incomplete.

If it is determined as Yes in Step S1205, that is, if it is determined that the failure countermeasures have not been completed, the processing proceeds to Step S1206. If it is determined as No in Step S1205, that is, if it is determined that the failure countermeasures have been completed, the processing proceeds to Step S1208.

In Step S1206, the device management server 101 determines whether there is a change in the error handling method before and after change of the product. A difference in the error handling method is determined based on whether or not there is a difference in any of “Error content” and “Dispatch” in the error code master information management table (Table 10).

For example, a case in which the product before change is MA005 and the product after change is MA002 will be described. Regarding the history of errors in the third row in the error history management table (Table 11), an error code E003 has a different value for “Dispatch” associated with the products before and after change.

In addition, the same error code is defined before and after change in this manner. In addition to the case in which the handling methods are different, the error code is not defined in the product before change, and a case in which the error handling method cannot be judged from the error code master information is also conceivable. Even in such a case, it is judged that the handling method differs.

In this manner, if the same error code is present but the handling method differs because the product has been changed properly, the handling method can be properly corrected. In addition, regarding an error for which the error handling method cannot be judged from the error code master information and the coping method is uncertain, the handling method can be checked.

If it is determined in Step S1206 that there is no change in the error handling method, the processing proceeds to Step S1211. If it is determined that there is a change in the error handling method, the processing proceeds to Step S1207.

In Step S1207, the device management server 101 notifies a person in charge (user) that the error handling method has been changed or ascertained. The notification is issued by sending an e-mail or the like to an e-mail address set in advance.

Meanwhile, in Step S1208, the device management server 101 judges whether or not a serviceman has been dispatched when coping with the error on the basis of “Dispatch result” in the error history management table (Table 11).

If it is determined as No in Step S1208, that is, if it is determined that “Dispatch result” is “No”, the processing proceeds to Step S1211. If it is determined as Yes in Step S1208, that is, if “Dispatch result” is “Yes”, the processing proceeds to Step S1209.

In Step S1209, it is determined whether or not the dispatch of a serviceman is valid. That is, the device management server 101 judges whether or not the error code of the error is defined as requiring dispatch for a proper product after change in the error code master information management table (Table 10). If it is defined as requiring dispatch, it is determined that dispatch of a serviceman is valid, and the processing proceeds to Step S1211.

Meanwhile, for example, if the error code is E003 and the product after change is MA002, it is defined as not requiring dispatch of a serviceman. However, in a history of errors, if a serviceman has been dispatched, it means that the dispatch which is originally unnecessary has been performed. Regarding this, for example, a case in which incorrect “M3-series” has been associated although “M1-series” should have been associated properly when a device is registered corresponds to this.

In the product code MA005 in “M3-series”, since the error code E003 is defined as requiring dispatch, a serviceman is dispatched in accordance therewith. In such a case, it is judged that dispatch of a serviceman is not valid, and the processing proceeds to Step S1210.

In Step S1210, the device management server 101 reallocates the expenses for dispatching a serviceman. Dispatching a serviceman incurs costs, but if dispatch which is originally unnecessary has been performed, change is made such that the department which made the operational error bears the costs.

For example, the device management server 101 also manages its own operational costs, and departments are set in advance to charge for the costs of valid dispatch of a serviceman and invalid dispatch of a serviceman so that the department to be charged for the costs of the dispatch is changed.

Subsequently, in Step S1211, it is determined whether or not any unchecked failure history remains, and if it is determined that it remains, that is, if it is determined as Yes in Step S1211, the processing returns to Step S1205. Meanwhile, if it is determined that checking of all error histories has been completed, that is, if it is determined as No in Step S1211, the processing proceeds to Step S1212.

In Step S1212, the device management server 101 corrects a failure report and recreates a report. For example, if a list of histories of errors is provided to a user as a report, and if the error content corresponding to each error code of the history of errors differs before and after the product change, it is switched to a proper error content.

Meanwhile, when an incorrect product has been associated, a proper error content is added to the history of errors which cannot be determined because there is no error code. Thereafter, the processing flow in FIG. 12 ends.

Here, Steps S1206, S1210, and S1211 function as a correcting step (correction unit) of correcting a history of errors. That is, in the correcting step, it is judged whether there is a change in the information of errors having a probability of occurrence in the devices on the basis of the changed information of the continuous printing speed received from the device. Further, if the information of the history of errors is incorrect, the history of errors is corrected based on the information of errors associated with the product information compatible with the continuous printing speed.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the device management server or the like through a network or various storage media. Then, a computer (or a CPU, an MPU, or the like) of the device management server or the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of Japanese Patent Application No. 2024-013186 filed on Jan. 31, 2024, and Japanese Patent Application No. 2024-180626 filed on Oct. 16, 2024 both of which are hereby incorporated by reference herein in its entirety.

What is claimed is:

1. A device management server which manages devices having a changeable continuous printing speed, the device management server comprising:
at least one processor or circuit configured to function as:
a storage unit configured to store product information of the devices and information of consumables used in the devices in association with the devices; and
a change unit configured to acquire information of an individual product compatible with the changed continuous printing speed from the storage unit on the basis of changed information of the continuous printing speed received from the device, to acquire information of consumables available in the individual product from the storage unit if the information of consumables associated with the device is not available in the individual product, and to perform change processing for reassociation with the device.

2. The device management server according to claim 1,
wherein if there are a plurality of consumables available in the individual product after change, recommended consumables are selected for the individual product after change as consumables to be reassociated.

3. The device management server according to claim 1,
wherein if there are a plurality of consumables available in the individual product after change, consumables to be reassociated are selected on the basis of an attribute of the associated information of consumables.

4. The device management server according to claim 1,
wherein if there are a plurality of consumables available in the individual product after change, consumables having been actually used are judged and selected as consumables to be reassociated on the basis of the number of printed sheets and a remaining amount of the consumables in printing results of the device.

5. The device management server according to claim 1,
wherein it is judged whether or not to automatically change association with consumables, and a user is notified that the association needs to be changed if it is judged not to perform automatic change.

6. The device management server according to claim 1,
wherein the change unit judges whether or not the change processing is possible on the basis of a change history of the continuous printing speed from the received changed information.

7. The device management server according to claim 1,
wherein the change unit does not perform the change processing if it is judged from the received changed information that the continuous printing speed has been changed temporarily.

8. A device management server which manages devices having a changeable continuous printing speed, the device management server comprising:
at least one processor or circuit configured to function as:
a storage unit configured to store product information of the devices and lifespan information of parts constituting the devices in association with the devices; and
a change unit configured to acquire lifespans of the parts associated with the product information corresponding to the changed continuous printing speed from the storage unit on the basis of changed information of the continuous printing speed received from the device, and to perform recalculation of a lifespan expiration date and a recommended replacement date if the lifespan of the part associated with the product information after change differs from that before change.

9. A device management server which manages devices having a changeable continuous printing speed, the device management server comprising:
at least one processor or circuit configured to function as:
a storage unit configured to store product information of the devices and information of parts constituting the devices in association with the devices; and
a change unit configured to acquire the information of parts constituting an individual product compatible with the changed continuous printing speed from the storage unit on the basis of changed information of the continuous printing speed received from the device, and to perform change processing for reassociation with the device.

10. A device management server which manages devices having a changeable continuous printing speed, the device management server comprising:
at least one processor or circuit configured to function as:
a storage unit configured to store product information of the devices, information of errors having a probability of occurrence in the devices, and histories of errors having occurred in the devices; and
a correction unit configured to judge whether there has been a change in the information of errors having a probability of occurrence in the devices on the basis of changed information of the continuous printing speed received from the device, and to correct the history of errors with the information of errors associated with the product information corresponding to the continuous printing speed if information of the history of errors is incorrect.

11. A device management method of managing devices having a changeable continuous printing speed, the method comprising:
storing product information of the devices and information of consumables used in the devices in association with the devices; and
acquiring information of an individual product compatible with the changed continuous printing speed on the basis of changed information of the continuous printing speed received from the device, acquiring information of consumables available in the individual product if the information of consumables associated with the device is not available in the individual product, and performing change processing for reassociation with the device.

12. A non-transitory computer-readable storage medium storing a computer program for a device management method of managing devices having a changeable continuous printing speed, including instructions for executing following processes:
storing product information of the devices and information of consumables used in the devices in association with the devices; and
acquiring information of an individual product compatible with the changed continuous printing speed on the basis of changed information of the continuous printing speed received from the device, acquiring information of consumables available in the individual product if the information of consumables associated with the device is not available in the individual product, and performing change processing for reassociation with the device.
